(19) United States
(12) Patent Application Publication
(10) Pub. No.: US 2004/0124768 A1
(43) Pub. Date: Jul. 1, 2004

(54) Organic EL display device

(75) Inventors: Gen Suzuki, Yonezawa-shi (JP); Naoki Yazawa, Yonezawa-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: TOHOKU PIONEER CORPORATION, Tendo-shi (JP)

(21) Appl. No.: 10/730,886

(22) Filed: Dec. 10, 2003

(30) Foreign Application Priority Data
Dec. 19, 2002 (JP) 2002-368045

(51) Int. Cl. H05B 33/00

(52) U.S. Cl. 313/504

(57) ABSTRACT

An organic EL structure body 2 is formed on a surface of a transparent substrate 1, and the EL structure body 2 is sealed by a metal airtight container 20. Circuit structure bodies such as an anode driver circuit 11 and a cathode driver circuit 12 are mounted on a part of the transparent substrate 1. These earth lines, for example, are commonly connected through conductors 21a and 21b. Therefore, the above-mentioned circuit structure bodies are mutually connected by the earth line of low impedance, so that an obstruction occurred in the EL display device under an earth line of high impedance can be suppressed.

### BACKGROUND OF THE INVENTION

1. Field of the Invention

The present invention relates to an organic EL (electroluminescence) display device using an organic material in a luminescence function layer.

2. Description of the Related Art

As shown in FIGS. 1(A) and 1(B), an organic EL display device is generally constituted by a transparent substrate and an organic EL structure body laminated on a surface of the substrate. In addition, FIG. 1(A) illustrates the substrate partially cut away in a perspective view, and FIG. 1(B) illustrates a state of the laminated layers of the organic EL structure body in a cross-sectional view. As shown in FIGS. 1(A) and 1(B), the organic EL structure body 2 as the laminated layers is obtained in such a way that first electrodes (anode lines) 3 are formed in stripes on the transparent substrate 1 by means of a sputtering process, for example, and a positive hole transport layer 4 is formed thereon by means of a vapor deposition process, for example.

Further, a luminescence function layer 5 of an organic compound is similarly formed on the positive hole transport layer 4 by means of the vapor deposition process. Still further, a plurality of second electrodes 6 (cathode lines) are formed on the luminescence function layer 5 in the direction perpendicular to the direction of the first electrodes. FIG. 1(A) shows one layer of the luminescence function layer 5 and one layer of the positive hole transport layer 4 by way of example.

As shown in FIG. 1(B), when an anode and a cathode of a direct current power supply E are connected to the first electrodes 3 and the second electrodes 6 respectively, a positive hole from the first electrode 3 and an electron from the second electrode 6 recombine at a pixel position where the first electrode 3 and the second electrode 6 intersect in the luminescence function layer 5 so as to emit light. The light due to the light-emission or luminescence is emitted via the transparent substrate 1, so that a picture image etc. are reproduced.

The above-mentioned substrate 1 may be of transparent glass, quarts, sapphire, or organic film. The anode lines 3 as the first electrodes may be of indium tin oxide (ITO). An aluminum alloy, for example, may be used for the cathode lines 6 as the second electrodes. Further, while the EL display device as shown in FIGS. 1(A) and 1(B) illustrates a configuration of a so-called passive drive system, while a configuration of an active drive system in which each pixel is further provided with a TFT (thin film transistor) for controlling the lighting has been also proposed.

In the case of the EL display device having either of the above-mentioned configurations, the above-mentioned organic EL structure body 2 has a problem of tending to be oxidized especially by moisture in atmosphere and to degrade the luminescence characteristic, when it is exposed to the atmosphere. To avoid such a problem, the organic EL structure body 2 is sealed by means of an airtight container and a desiccant is included within the airtight container. An organic EL display device provided with such a means is disclosed in Japanese Patent Application Laid-Open (kokai) H9-148066 (see paragraphs 0010 and 0011 and FIG. 1).

On the other hand, FIG. 2 shows an example of a drive circuit in the EL display device of the passive drive system. Anode lines A1 to An are arranged as n driving lines in the vertical direction, and cathode lines B 1 to Bm are arranged as m scanning lines in a lateral direction. Organic EL elements OEL indicated by a diode symbol are formed and arranged in positions where the anode lines and the cathode lines are intersected respectively (n×m positions in total), so as to constitute the EL structure body 2. The above-mentioned anode lines A1 to An are equivalent to the first electrodes as denoted by the reference numeral 3 in FIG. 1, and the above-mentioned cathode lines B1 to Bm are equivalent to the second electrodes denoted by the reference numeral 6 in FIG. 1.

Then, each of the anode lines A1 to An is connected to an anode driver circuit (a anode drive IC (integrated circuit)) 1, and each of the cathode lines B1 to Bm is connected to a cathode driver circuit (a cathode drive IC) 12, so as to be driven respectively. The above-mentioned cathode driver circuit 12 is provided with scanning switches SY1 to Sym corresponding to the cathode lines B1 to Bm respectively, so as to apply either a reverse bias voltage VM from a reverse bias voltage generating circuit 14 for preventing a cross talk emission in the EL element or an earth voltage as a reference potential point to the corresponding cathode lines.

In addition, the anode driver circuit 11 is provided with constant current circuits I1 to In for supplying drive currents to respective EL elements through respective anode lines and the drive switches SX1 to SXn. Each of the drive switches SX1 to SXn acts to supply either the current from each of the constant current circuits I1 to In or the earth voltage to each of the corresponding anode lines. Therefore, by connecting the drive switches SX1 to SXn to the above-mentioned constant current circuits, the currents from the constant current circuits I1 to In act to be respectively supplied to the EL element arranged so as to correspond to the cathode lines.

The above-mentioned anode driver circuit 11 and the cathode driver circuit 12 are respectively connected to controller buses which are extended from a controller circuit (controller IC) 13 containing a CPU (central processing unit). The above-mentioned scanning switches SY1 to Sym and the drive switches SX1 to SXn are operated based on an image signal supplied to the controller circuit 13. Thus, the constant current circuits I1 to In are suitably connected to desired anode lines, while setting cathode lines to the earth voltage at predetermined time intervals based on the image signal. Therefore, each of the above-mentioned EL elements emits light selectively, and the image based on the above-mentioned image signal is reproduced.

The constant current circuits I1 to In in the above-mentioned anode driver circuit 11 are constructed to be supplied with DC power (output voltage=VH) from a drive voltage source 15 such as a booster type DC to DC converter, so that the constant currents generated by the above-mentioned constant current circuits I1 to In supplied with the output voltage VH from the drive voltage source 15 act to be supplied to the respective EL element arranged corresponding to the anode lines.

On the other hand, the reverse bias voltage VM used for preventing the cross talk emission in the above-mentioned EL element may be obtained by means of resisters R1 and R2 which divide the output voltage VH from the above-mentioned drive voltage source 15 and a transistor Q1 which carries out impedance conversion of the divided and outputted voltage.

In these days, the above-mentioned organic EL display device has been devised in such a way that, while forming the above-mentioned EL structure body 2 on the transparent substrate, a drive IC (integrated circuit) and a control IC (integrated circuit) for electrically driving the above-mentioned EL structure body are mounted on the transparent substrate etc. Such a means is referred to as a COG (Chip on Glass). By employing the above-mentioned means, the number of wiring connections between the transparent substrate and an external circuit can be considerably decreased, to thereby reduce an occupied volume of the EL display device and a circuit structure accompanying the EL display device.

However, for example, when the above-mentioned COG means is employed, the number of wiring patterns formed on the transparent substrate increases further, which limits a formation width of the wiring pattern, so that it becomes difficult to reduce a value of resistance (impedance) of each wiring pattern.

In other words, FIG. 2 equivalently shows a typical example of resistances produced in the wiring pattern, when the COG means is employed in which the anode drive circuit 11, the cathode drive circuit 12, and the controller circuit 13 are integrated into an IC and mounted on the transparent substrate having formed the EL structure body 2. The circuit structure as shown in FIG. 2 is substantially constructed in such a way that a resistance Rx1 is connected between the controller circuit 13 and the reference potential point, a resistance Rx2 is connected between the cathode drive circuit 12 and the reference potential point, and further a resistance Rx3 is connected between the anode drive circuit 11 and the reference potential point.

In addition, for convenience of illustration, FIG. 2 shows a state where the resistances are produced on an earth line, however, similar resistance may occur on power supply line etc., of course. When a resistance of a comparatively large value as described above exists, for example, on the earth line or the power supply line, the drive circuit tends to gather an external noise and a possibility of making an IC cause incorrect operation may increase. Further, another problem arises in that a level of unnecessary radiation generated by the drive circuit etc. also increases, the cross talk emission increases, and a so-called in-plane luminance inclination in which an emission luminosity shifts on a display surface of a display generates considerably.

Further, because of the resistances in the above-mentioned wiring pattern, an operation of resetting the cathodes may become insufficient, so that another problem arises in that the emission duty substantially falls because of the longer operational time, and a level of noises increases which radiate externally from the drive IC etc.

### SUMMARY OF THE INVENTION

In view of the above technical problems, the present invention is made, and an object of the present invention is to provide an organic EL display device capable of solving the above-mentioned problems by effectively using the above-mentioned airtight container for sealing the EL structure body.

The organic EL display device according to the present invention which has been made to solve the above-mentioned problems, is an organic EL display device having formed an organic luminescence functional layer between a pair of electrodes formed on a substrate and having an airtight container for sealing the organic EL structure body which includes the above-mentioned electrodes and the organic luminescence functional layer, and characterized in that the above-mentioned airtight container is provided with at least one type of voltage.

### BRIEF DESCRIPTION OF THE DRAWINGS

FIGS. 1(A) and 1(B) are schematic representations showing an example of an organic EL structure body used for a display device according to the present invention;

FIG. 2 is an equivalent circuit diagram showing an example of a substantial drive circuit in a conventional EL display device;

FIGS. 3(A) and 3(B) are respectively a plan view and a side elevational view showing a first preferred embodiment of the EL display device according to the present invention;

FIG. 4 is an equivalent circuit diagram showing an example of a substantial drive circuit when the present invention is employed;

FIGS. 5(A) and 5(B) are respectively a plan view and a side elevational view showing a second preferred embodiment of the EL display device according to the present invention;

FIGS. 6(A) and 6(B) are respectively a plan view and a side elevational view showing a third preferred embodiment according to the present invention;

FIGS. 7(A) and 7(B) are respectively a plan view and a cross-sectional view showing an example of structure of the airtight container used for the EL display device according to the present invention;

FIG. 8 is a plan view showing another example of structure of the airtight container according to the present invention;

FIG. 9 is a plan view showing still another example of structure of the airtight container according to the present invention.

### DETAILED DESCRIPTION OF PREFERRED EMBODIMENTS

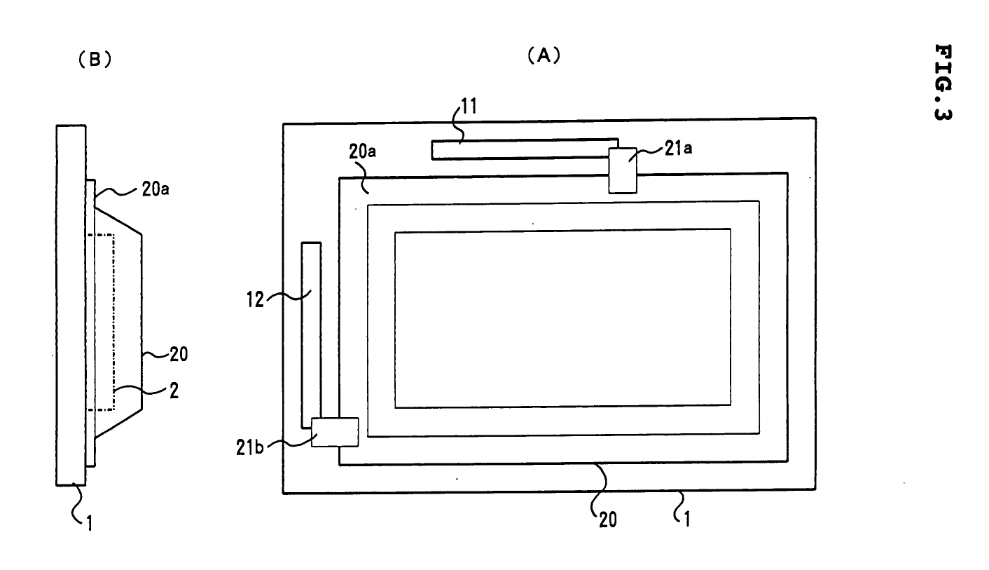

Hereafter, a preferred embodiment of an organic EL display device according to the present invention will be described based on the figures. FIGS. 3(A) and 3(B) show a first preferred embodiment of the organic EL display device according to the present invention, FIG. 3(A) shows a state when viewed from a top side, FIG. 3(B) shows a state when viewed from a left lateral surface side.

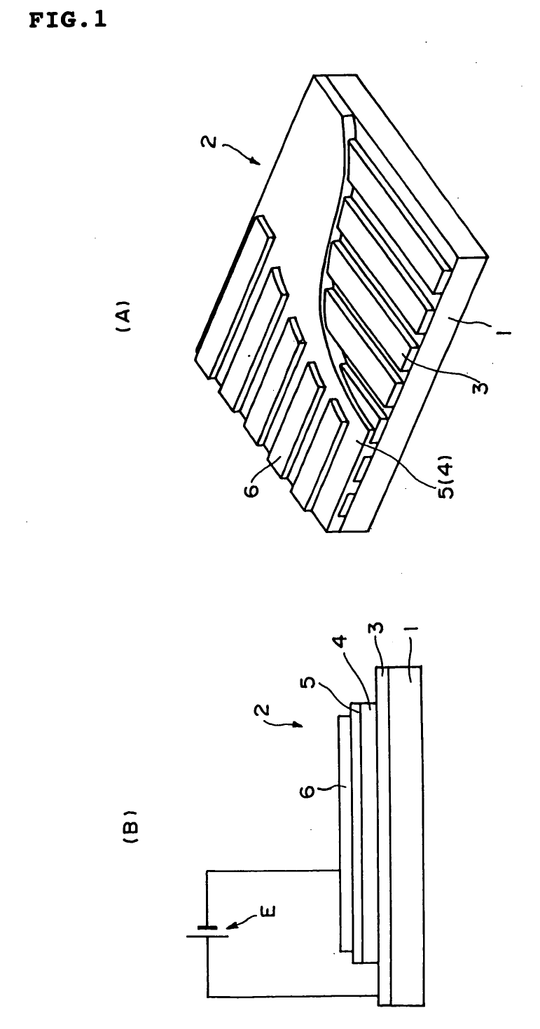

In the display device as shown in FIGS. 3(A) and 3(B), the same organic EL structure body 2 as the structure as described based on FIGS. 1(A) and 1(B) is formed on a surface of a glass substrate 1. In addition, the anode driver circuit 11 which is integrated into an IC as a circuit structure body and the cathode driver circuit 12 which is similarly integrated into an IC as a circuit structure body are mounted on the surface of the glass substrate 1, therefore the above-mentioned COG means is employed in the preferred embodiment. A region where the EL structure body 2 is formed is sealed by a metal (conductive material, such as SUS) airtight container 20.

In a preferred embodiment shown in FIGS. 3(A) and 3(B), the above-mentioned airtight container 20 is formed substantially in a rectangular shape when viewed from the top surface, substantially in a trapezoidal shape when viewed in a lateral direction, and a flat sealed space is formed therein. A flange portion 20a formed on all sides of the airtight container 20 constitutes a joint portion with respect to a substrate 1, and the container 20 is adhered to a substrate face with an adhesive (not shown) which is interposed between the joint portion and the substrate so as to seal the EL structure body 2 in an airtight state.

In the preferred embodiment, a conductor 21a (for example, an aluminum thin film) formed in a rectangular shape is provided between the operational reference potential point in the anode driver circuit 11 mounted on the substrate face and the container 20 adhered to the substrate face, so as to connect both electrically. Further, a conductor 21b (similarly, an aluminum thin film), formed in a rectangular shape is provided between an operational reference potential point in the cathode driver circuit 12 similarly mounted on the substrate face and the above-mentioned container 20 adhered to the substrate face, so as to connect both electrically.

Therefore, according to the structure as shown in FIGS. 3(A) and 3(B), the anode driver circuit 11 and the cathode driver circuit 12 which are mounted on the substrate face are commonly connected to the airtight container 20 constituted by a metal, so that its electric potential is caused to be the reference potential of each of the driver circuits 11 and 12. Further, in the preferred embodiment as shown in FIG. 3, although a case where the anode driver circuit 11 and the cathode driver circuit 12 are mounted on the surface of the substrate 1 is illustrated, the above-mentioned controller circuit 13 which provides a control signal based on the image signal to each of the driver circuits 11 and 12 may be further mounted on the surface of the same substrate 1 in the form of the IC.

Thus, when the controller circuit 13 is further mounted on the surface of the substrate 1, it is preferable to connect the reference potential point in the controller circuit 13 to the metal airtight container 20 through a conductor, such as an aluminum thin film similarly.

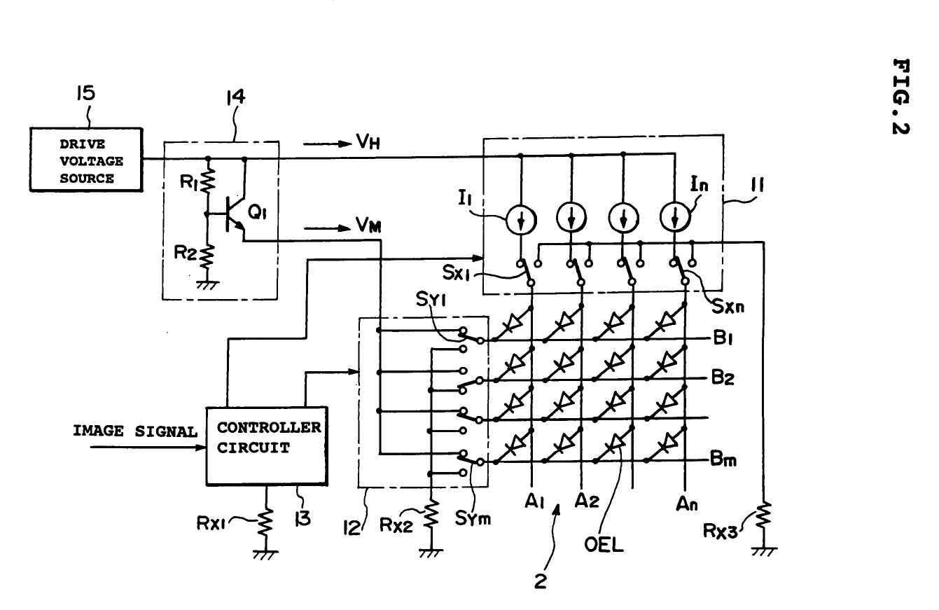

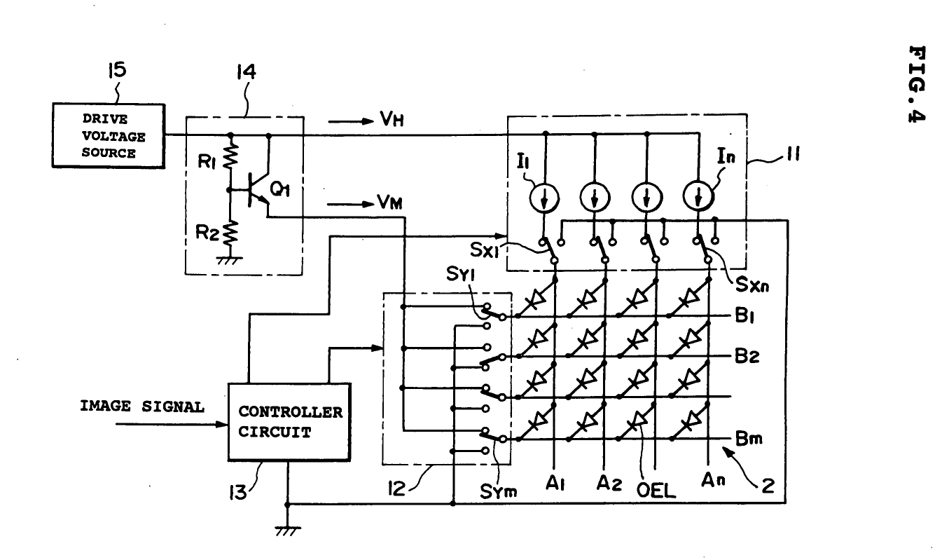

FIG. 4 shows an equivalent circuit when each of the drive circuits 11 and 12 as well as the controller circuit 13 are mounted on the surface of the substrate 1 and commonly connected with each reference potential (earth line) through the metal airtight container 20. In addition, in FIG. 4, the same reference numerals are used to indicate corresponding parts in the circuit structure as shown in FIG. 2 and as described above, therefore each explanation will be omitted.

According to this structure, since the earth line of each of the driver circuits 11 and 12 and the controller circuit 13 are commonly connected by the metal airtight container 20, a value of a resistance (impedance) generated in the earth line of each circuit can be reduced as small as possible. That is, the resistances Rx1 to Rx3 as equivalently shown in FIG. 2 may be rendered small to the extent that their existence is disregarded.

Therefore, it is possible to solve several problems, such as the problem of the above-mentioned external noise generated due to the existence of the above-mentioned resistances Rx1 to Rx3, the problem of the unnecessary radiation, the increase in the cross talk emission, and the greater in-plane luminance inclination.

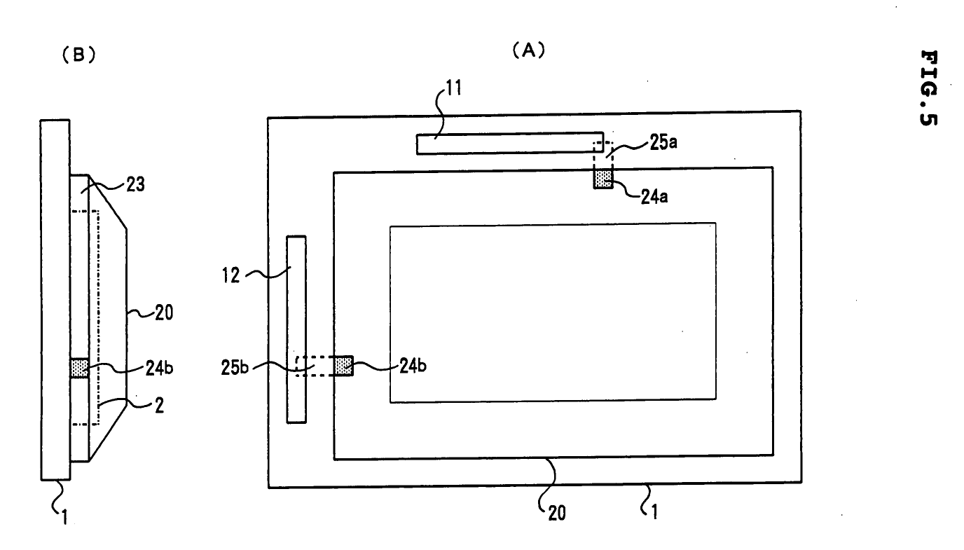

Next, FIGS. 5(A) and 5(B) show a second preferred embodiment of the organic EL display device according to the present invention. FIG. 5 (A) shows a state when viewed from the top side, and FIG. 5 (B) shows a state when viewed from a left lateral surface side. Also in the display device as shown in FIG. 5, the similar organic EL structure body 2 is formed on the surface of the glass substrate 1. In addition, on the surface of the glass substrate 1, the anode driver circuit 11 and the cathode driver circuit 12 which are integrated into the IC as the circuit structure body are similarly mounted.

In the preferred embodiment as shown in FIGS. 5(A) and 5(B), the metal airtight container 20 is constructed to seal the region where the EL structure body 2 is formed through the spacer 23 provided with predetermined thickness. In other words, the above-mentioned spacer 23 is adhered to the surface of the substrate 1 via the adhesive (not shown). Further the above-mentioned airtight container 20 is constructed to connect to a top surface of the spacer 23 via the adhesive (not shown).

In the preferred embodiment as shown in FIG. 5(A) and 5(B), the above-mentioned airtight container 20 is formed substantially in a rectangular shape when viewed from the top surface, and substantially in a trapezoidal shape when viewed in the lateral direction, and the flat sealed space is formed therein. Edges formed on all sides of the airtight container 20 constitute the joint portion with respect to the above-mentioned spacer 23. The organic EL structure body 2 is constructed to be sealed in the airtight state by means of the airtight container 20 and the above-mentioned spacer 23.

In the preferred embodiment, a first and a second conductors 24a and 24b are embedded in a part of above-mentioned spacer 23 along a thickness direction of the spacer 23. These conductors 24a and 24b are constructed to be in contact with the above-mentioned metal container 20, and also contact with conduction lines 25a and 25b by means of ITO or aluminum wiring which are formed on the surface of the substrate 1 where the conductors 24a and 24b are arranged. On the other hand, one conduction line 25a formed on the surface of the substrate 1 is connected to the operational reference potential point in the anode driver circuit 11, and the other conduction line 25b is connected to the operational reference potential point in the cathode driver circuit 12.

Therefore, according to the structure as shown in FIGS. 5(A) and 5(B), by means of the operational reference potential, the anode driver circuit 11 and the cathode driver circuit 12 mounted on the surface of the substrate are commonly connected to the airtight container 20 constituted by the metal. In addition, also in the embodiment as shown in FIGS. 5(A) and 5(B), although a case where the anode driver circuit 11 and the cathode driver circuit 12 are mounted on the surface of the substrate 1 is illustrated, the above-mentioned controller circuit 13 which provides the control signal based on the image signal to each of the driver circuits 11 and 12 may also be further mounted on the surface of the substrate 1 in the form of the IC.

Thus, when the controller circuit 13 is mounted on the surface of the substrate 1, the reference potential point in the controller circuit 13 may connect to the container 20 through the conductor of a similar structure embedded in a part of the spacer 23 similarly.

Therefore, also in the above-mentioned structure, it is possible to reduce the value of the resistances generated in the earth line etc. of each circuit as small as possible, so that the resistances Rx1 to Rx3 as equivalently shown in FIG. 2 may be rendered small to the extent that their existence is disregarded. Consequently, it is possible to solve several problems, such as the problem of the above-mentioned external noise generated due to the existence of the above-mentioned resistances Rx1 to Rx3, the problem of the unnecessary radiation, the increase in the cross talk emission, and the greater in-plane luminance inclination.

In addition, in the structure shown in FIG. 5, it is preferable that the above-mentioned airtight container 20 side which faces an arranged position of each of the conductors 24a and 24b is processed to be uneven or irregular, to thereby further improve reliability of electric connections between the conductors 24a and 24b and the container 20.

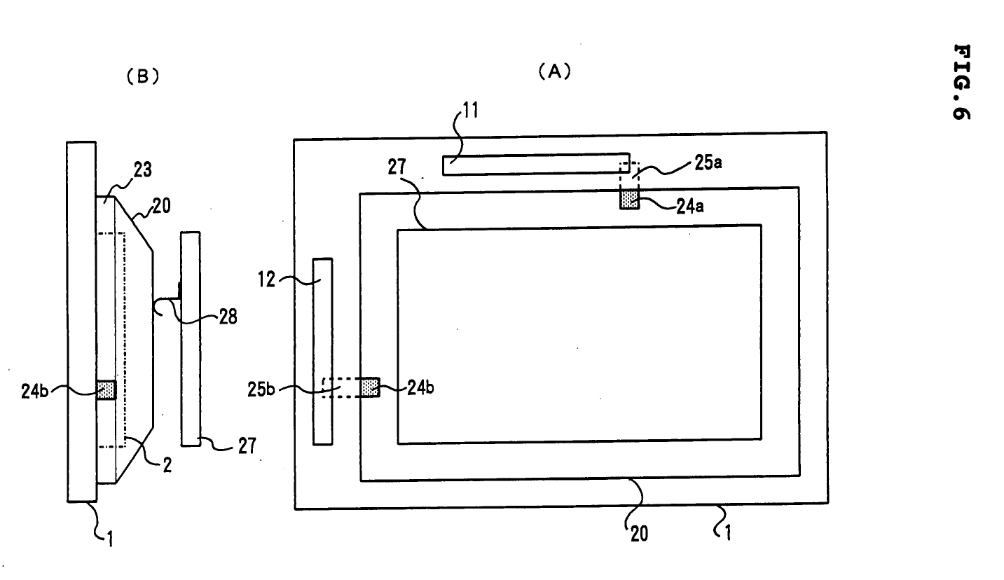

FIGS. 6(A) and 6(B) show a third preferred embodiment of the organic EL display device according to the present invention. FIG. 6(A) shows a state when viewed from a top surface side, and FIG. 6(B) shows a state when viewed from a left lateral surface side. In addition, the structure of the EL display device as shown in FIG. 6 is basically the same as the structure as shown in FIG. 5, and the same reference numerals are used to indicate corresponding parts.

In the third preferred embodiment as shown in FIGS. 6(A) and 6(B), an example of a preferred connection structure between the EL display device as described based on FIGS. 5(A) and 5(B) and another circuit substrate etc. is provided. In other words, it is often the case that a circuit substrate 27 having mounted thereon another circuit structure is disposed on the back face of the EL display device. In such a structure as described above, by bringing the circuit substrate 27 into contact with the back face of the container 20 through the metal conductor 28 mounted on the circuit substrate 27 as shown in FIG. 6(B), for example, the reference potential point of the circuit substrate 27 can be rendered common to that of the EL display device.

In addition, in the example as shown in the figure, the above-mentioned conductor 28 mounted on the circuit substrate 27 employs a metal plate formed in the rectangular shape whose end is folded into a U-shape, however, one having an arbitrary shape can be used. As for the preferred embodiment as shown in FIGS. 6(A) and 6(B) also, it is possible to obtain the same operations and effects as those of the preferred embodiment as shown in FIGS. 5(A) and 5(B). Further, it is possible to realize the connection of the earth line with another circuit structure except for the EL display device with low impedance, for example.

The preferred embodiments as described above are each constructed in such a way that the circuits are mutually connected by means of the reference potential points through the metal airtight container. However, according to the present invention, another potential other than the above-mentioned reference potential points, such as for example a voltage of the power supply for operating the circuits may be applied through the metal airtight container. In this case, the impedance in the supply line of the operational power supply can be effectively reduced.

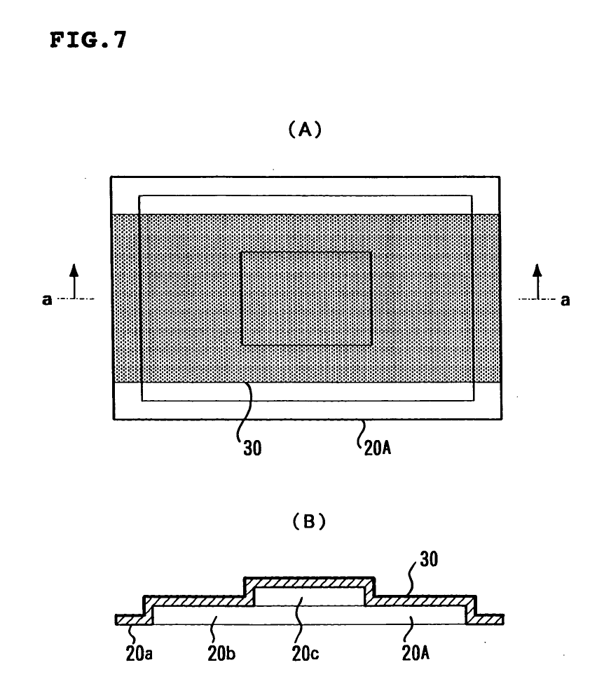

FIGS. 7(A), 7(B), 8 and 9 show other examples of the above-mentioned airtight container which constitutes a part of the EL display device according to the present invention. Each shows the example when using non-conductive materials, such as for example glass, a synthetic resin, etc. FIGS. 7(A) and 7(B) show a first example. FIG. 7(A) is a front elevational view when the container is viewed from its top surface side, and FIG. 7(B) shows a cross-sectional view of a state when viewed from a line a-a in a direction of arrows in FIG. 7(A).

In the airtight container 20A as shown in FIGS. 7(A) and 7(B), the flange portion 20a formed on all the sides of container 20A constitutes the joint portion to the transparent substrate, as shown in the cross-sectional view. A space portion 20b formed in a flat shape within the container 20A constitutes the sealed space for accommodating the above-mentioned organic EL structure body 2. In addition, in the embodiment as shown in FIGS. 7(A) and 7(B), a space portion 20c is formed to further project in a substantial center of the sealed space, and the space portion 20c is constructed to include a drying desiccant, for example.

On the other hand, as shown in FIG. 7 (A), a conductive layer 30 is formed on an upper surface of the container 20A. As shown in the figure, the conductive layer 30 is formed to occupy a greater part of a middle of the container, along a longitudinal direction of the container 20A. Therefore, by using the container 20A of the above-mentioned structure, the EL display device as shown in FIGS. 3(A) and 3(B), 5(A) and 5(B), or 6(A) and 6(B) can be provided. By using the above-mentioned conductive layer 30 formed in the container 20A, the circuit structure bodies such as the above-mentioned driver circuit 11 and 12 can be commonly connected.

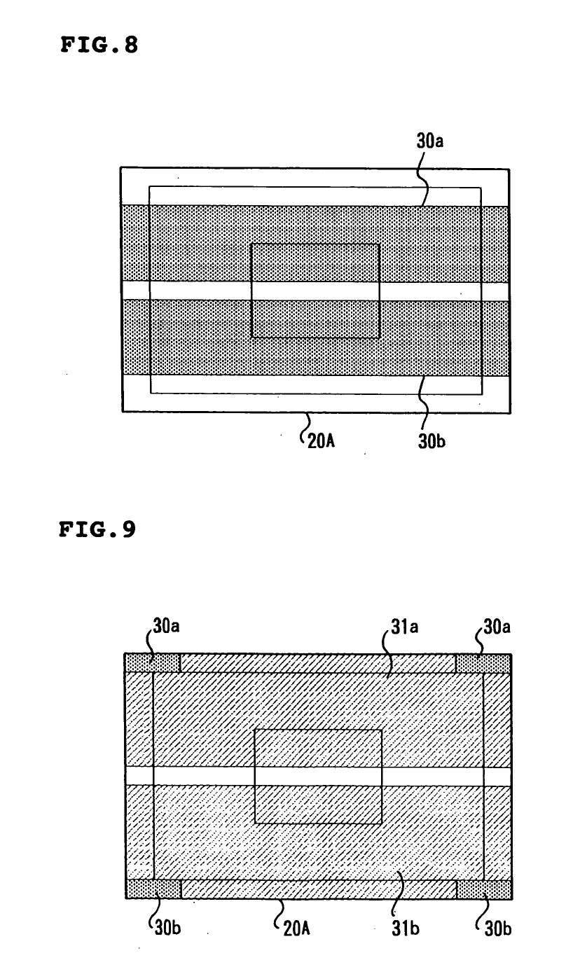

FIG. 8 shows a second example of the airtight container 20A formed of a non-conductive material, and an appearance structure of the airtight container 20A in this example is the same as shown in FIGS. 7(A) and 7(B). Then, two conductive layers 30a and 30b are formed in parallel along the longitudinal direction of the container 20A on the upper surface of the container 20A. By using the container 20A of the above-mentioned structure, the EL display device as shown in FIGS. 3(A) and 3(B), 5(A) and 5(B), or 6(A) and 6(B) can be provided similarly.

In the container 20A as shown in FIG. 8, the circuit structure bodies such as the above-mentioned driver circuits 11 and 12 can be commonly connected, by using two conductive layers 30a and 30b. In this case, they can be commonly connected by using one conductive layer 30a as an earth lines, and commonly connected by using the other conductive layer 30b as a supply line for the operational power supply, for example.

FIG. 9 shows a third example of the airtight container 20A formed of a non-conductive material, and the appearance structure of the airtight container 20A in this example is also the same as shown in FIG. 7(A), 7(B) and 8. While two conductive layers 30a and 30b are formed in parallel in the upper surface of container 20A along the longitudinal direction of the container 20A, insulating layers 31a and 31b are formed so as to cover these conductive layers 30a and 30b. In addition, the above-mentioned insulating layers 31a and 31b each leave a part uninsulated, so that the above-mentioned conductive layers 30a and 30b may be exposed in the part.

Therefore, according to the structure as shown in FIG. 9, the circuit structure bodies such as the above-mentioned driver circuits 11 and 12 can be commonly connected in the exposed part of the conductive layers 30a and 30b. Since most of the upper surface of the container 20A is covered with insulating layers 31a and 31b according to the structure as shown in FIG. 9, it is possible to avoid disadvantages, such as a careless contact with other electric components, circuit structure bodies, etc., which may cause a short circuit.

In addition, in the airtight container 20A as shown in FIGS. 7(A), 7(B), 8 and 9, although each forms the conductive layer on the upper surface of the container 20A, the conductive layer can be also formed on an inner surface of the container 20A. This conductive layer can be used as a common connection means of the circuit structure body. Further, when employing a means for forming the airtight container 20A in layers, the above-mentioned conductive layer can be formed between the layers so as to be utilized similarly.

What is claimed is:

1. An organic EL display device including an airtight container for sealing an organic EL structure body having an organic luminescence function layer formed between a pair of electrodes formed on a substrate, in which said airtight container is provided with at least one potential.

2. The organic EL display device as claimed in claim 1, wherein said airtight container is constituted by a conductive material.

3. The organic EL display device as claimed in claim 1, wherein said airtight container is constituted by a non-conductive material and at least one layer of conductive layer is formed at said airtight container.

4. The organic EL display device as claimed in any one of claims 1 to 3, wherein an insulating layer of a non-conductive material is formed on a surface of said airtight container.

5. The organic EL display device as claimed in claim 1, wherein said potential includes a reference potential point.

6. The organic EL display device as claimed in any one of claims 1 to 3, wherein a conductor in contact with the airtight container is disposed in at least one place in order to apply a potential to said airtight container.

7. The organic EL display device as claimed in claim 4, wherein the conductor in contact with the airtight container is disposed in at least one place in order to apply a potential to said airtight container.

8. The organic EL display device as claimed in claim 5, wherein the conductor in contact with the airtight container is disposed in at least one place in order to apply a potential to said airtight container.

9. The organic EL display device as claimed in any one of claims 1 to 3, wherein in addition to said organic EL structure body, a circuit structure body for driving the organic EL structure body is mounted on said substrate, and the potential applied to said airtight container is at least one potential used in said circuit structure body.

10. The organic EL display device as claimed in claim 4, wherein in addition to said organic EL structure body, the circuit structure body for driving the organic EL structure body is mounted on said substrate, and the potential applied to said airtight container is at least one potential used in said circuit structure body.

11. The organic EL display device as claimed in claim 5, wherein in addition to said organic EL structure body, the circuit structure body for driving the organic EL structure body is mounted on said substrate, and the potential applied to said airtight container is at least one potential used in said circuit structure body.

12. The organic EL display device as claimed in claim 6, wherein in addition to said organic EL structure body, the circuit structure body for driving the organic EL structure body is mounted on said substrate, and the potential applied to said airtight container is at least one potential used in said circuit structure body.

13. The organic EL display device as claimed in claim 7 or 8, wherein in addition to said organic EL structure body, the circuit structure body for driving the organic EL structure body is mounted on said substrate, the potential applied to said airtight container is at least one potential used in said circuit structure body.
